(19) United States
(12) Patent Application Publication
(10) Pub. No.: US 2006/0195794 A1
(43) Pub. Date: Aug. 31, 2006

(54) User interface element property customization

(75) Inventors: Feng Sun, Issaquah, WA (US); Kollen Glynn, Newcastle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/067,967

(22) Filed: Feb. 28, 2005

(51) Int. Cl. G06F 3/00

(52) U.S. Cl. 715/762; 715/700

(57) ABSTRACT

User interface element property customization is provided. An application requiring a user interface attempts to load a user interface modification resource. If the resource fails to load, a default user interface is provided. However, if the resource successfully loads, modifications set forth in the resource are applied to appropriate user interface elements. The modification resource can be in the form of Extensible Markup Language (XML), a database, or any other suitable data storage format. As each customization is applied to each user interface element, information about the user interface code itself is used to adjust the customization information prior to application of the customization information to the user interface element. Finally, if the layout of the user interface will be impacted by the customization, the layout is preferably accommodated by adjusting the layout of one or more other user interface elements.

### BACKGROUND OF THE INVENTION

The present invention relates to computer user interfaces.

User interfaces are the primary means by which computer users interact with computers. A user interface generally includes a display of one or more controls that provide information to a user, generally in visual form, and receive information from the user to instruct a computing device. One of the primary goals of user interface design is to provide a host of functions to a user in a simple, intuitive form.

As computer software and hardware provide more and more complex functionality, it becomes increasingly important to provide user interfaces that allow users to navigate such complex functionality in a relatively simple and intuitive manner. One area where more and more complex functionality is being provided is in automated business applications. Such software is generally used by a business to automate, or electronically facilitate some or all of the business's functions. For example, computers are now used to track inventory, manage a human relations department, perform accounting functions, as well as a host of other functions. Since virtually ever company's demands for a business application vary, it would be inefficient to write a complete business solution for each such company from scratch. Instead, such applications are generally created in two parts. First, a software company, such as Microsoft Corporation of Redmond, Wash., will create a development framework to provide significant tools and software classes related to businesses. Then, a developer, such as an Independent Software Vendor (ISV), will build a tailored or customized business application specific to a company using the framework application. This regime is highly successful in that it provides extremely powerful and adaptable tools in such a manner that they can be significantly tailored and customized in order to match a company's needs.

One potential drawback of the manner in which such software is developed, is that if the company or ISV wishes to alter the manner in which the user interface is displayed, or any parameter therein, it is necessary for the source code of the application to be modified. When the source code is modified, it is also then necessary to recompile the source code in order to provide a working altered application. This process is cumbersome because it requires significant work from the ISV. Thus, users of such software and/or ISVs have been discouraged from making changes to user interface elements in these types of situations.

It would be a significant benefit to the art if the user interfaces could be more easily changed or customized, without having to recompile the source code.

### SUMMARY OF THE INVENTION

User interface element property customization is provided. An application requiring a user interface attempts to load a user interface modification resource. If the resource fails to load, a default user interface is provided. However, if the resource successfully loads, modifications set forth in the resource are applied to appropriate user interface elements. The modification resource can be in the form of Extensible Markup Language (XML), a database, or any other suitable data storage format. As each customization is applied to each user interface element, information about the user interface code itself is used to adjust the customization information prior to application of the customization information to the user interface element. Finally, if the layout of the user interface will be impacted by the customization, the layout is preferably accommodated by adjusting the layout of one or more other user interface elements.

### BRIEF DESCRIPTION OF THE DRAWINGS

FIG. 1 is a block diagram of one computing environment in which the present invention may be practiced.

FIG. 2 is a block diagram, of an alternative computing environment in which the present invention may be practiced.

FIG. 3 is a diagrammatic view of user interface generation in accordance with the prior art.

FIG. 4 is a diagrammatic view of user interface generation in accordance with an embodiment of the present invention.

FIG. 5 is a flow diagram of a method of generating a user interface in accordance with embodiments of the present invention.

FIG. 6 is a flow diagram of a method for applying a customization to a user interface element in accordance with an embodiment of the present invention.

### DETAILED DESCRIPTION OF ILLUSTRATIVE EMBODIMENTS

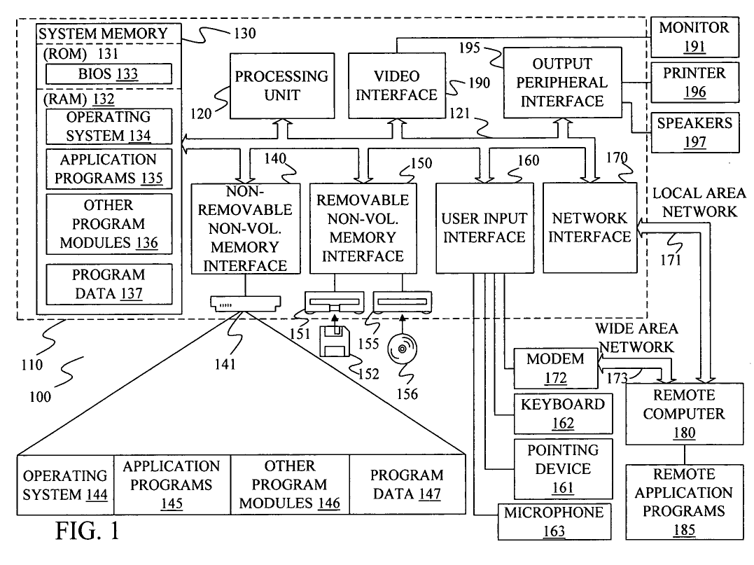

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

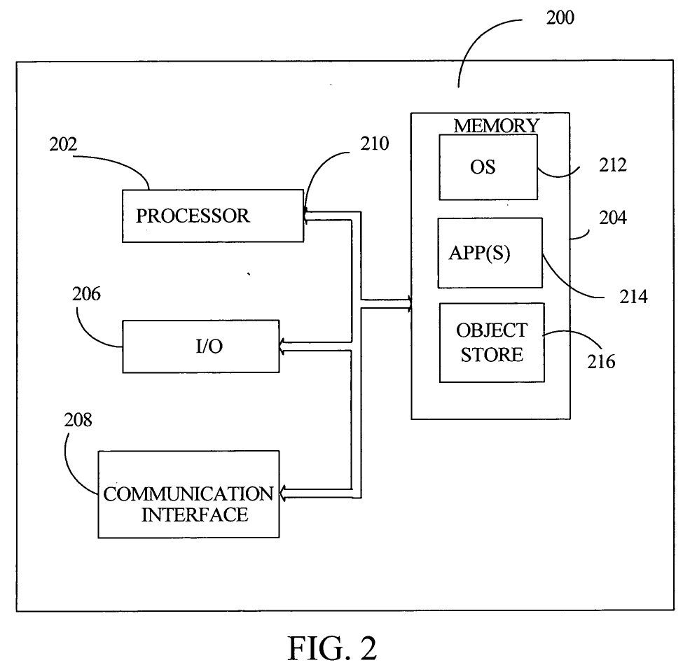

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

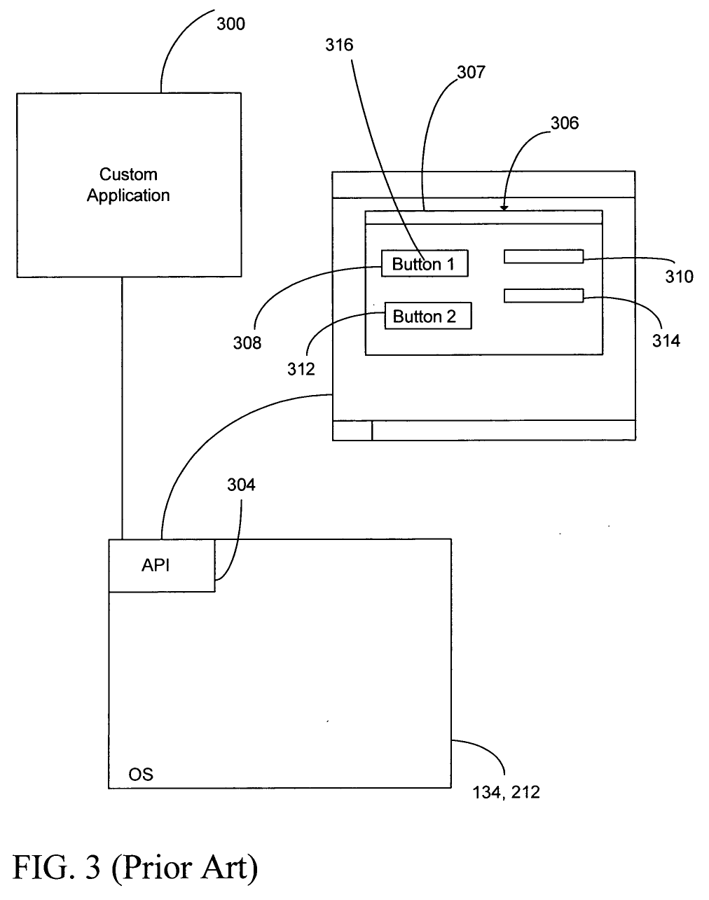

FIG. 3 is a diagrammatic view of user interface generation in accordance with the prior art. In the past, an application, even a customized application, such as application 300 generated by an independent software vendor (ISV) would generate user interface 306 on a suitable display, such as monitor 191, by making appropriate calls to operating system 134 via one or more application programming interfaces 304. User interface 306, generated by application 300, may include one or more windows 307 each having one or more controls 308, 310, 312, and 314. It is common for a control, such as button 308 to have label text 316 to provide the user with an indication of the function of button 308. If, during the lifetime of application 300, the function of the button were to be changed, or, even the user's requirements relative to the button's description were to change, it would become useful to be able to change description 316. However, in the past, it was generally necessary to recompile application 300 in order to give effect to this change.

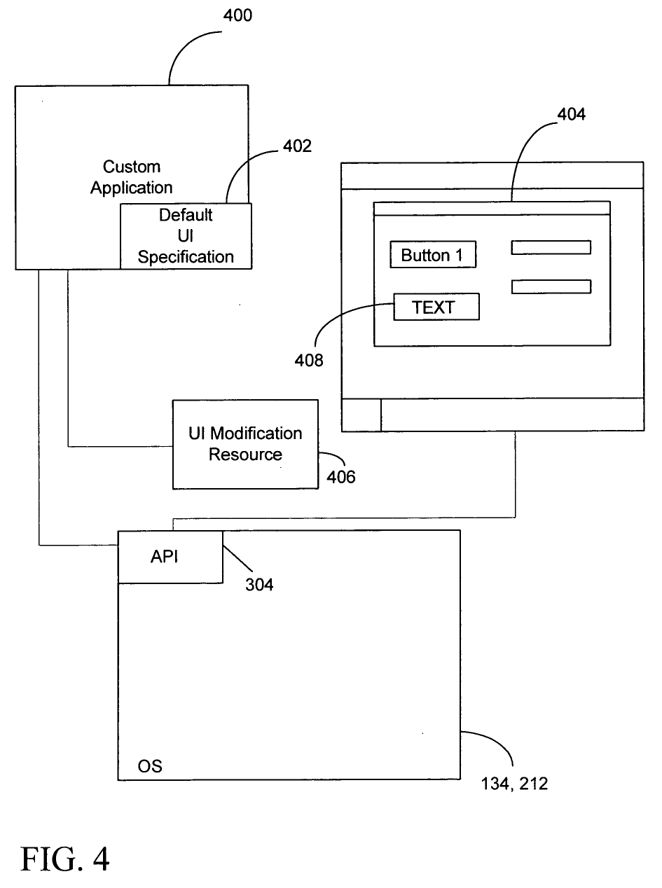

FIG. 4 is a diagrammatic view of generation of a user interface in accordance with an embodiment of the present invention. Application 400 includes, or is provided with, default user interface specification 402. Specification 402 may take the form of a user interface that is hard-coded into the programming instructions of application 400. However, specification 402 need not be contained within application 400. Default user interface specification 402 can be any set of instructions or data that completely define user interface 404.

As illustrated, custom application 400 preferably employs operating system 134, 212 to generate user interface 404 via one or more application programming interfaces 304. In accordance with one embodiment of the present application, custom application 400 accesses user interface modification resource 406. Resource 406 may take any suitable form including an Extensible Markup Language (XML) file, or a database, or any other suitable data structures. Resource 406 includes information relative to one or more modifications to be made to the default user interface specification 402 at run-time. When application 400 is initialized, it attempts to access external resource 406. If resource 406 is not found, application 400 simply loads as normal using default user interface specification 402. However, if custom application 400 does successfully load resource 406, it will parse the contents of resource 406. Resource 406 preferably includes specific information relative to individual user interface elements and their associated properties and the values of those properties. Only user interface elements that are to be changed are generally specified in resource 406. Accordingly, application 400 will apply the property changes to specific user interface elements specified in resource 406 and then load user interface 404. For example, while default user interface specification 402 may specify user interface 404 identically to user interface 306 (illustrated in FIG. 3), button 408 of interface 404 can have a different label (illustrated as “TEXT”) be specifying in resource 406 that button 408 should have a label that reads “TEXT.” Accordingly, this change is made at run-time without requiring application 400 to be re-compiled. Further, any property or value of any element of user interface 404 can be modified by placing such modification in resource 406.

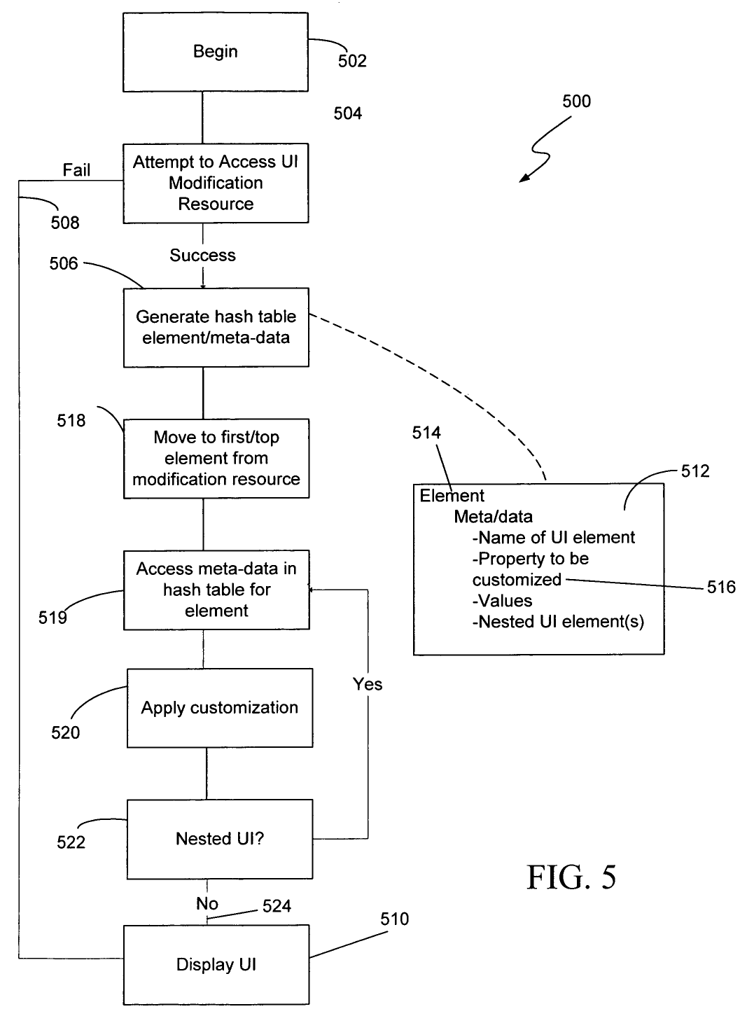

FIG. 5 is a flow diagram of a method of generating a user interface in accordance with embodiments of the present invention. Method 500 begins at block 502, which occurs when application 400 loads. At block 504 application 400 attempts to access a user interface modification resource, such as resource 406. Within block 504, it is important for application 400 to know the location of resource 406. In one embodiment, the location of resource 406, whether it is located on the local machine, or across a network, is preferably hard-coded into application 400. However, other embodiments of the invention include presenting the user with a choice of possible locations, or even allowing the user to enter the location information. If application 400 successfully loads resource 406, control passes to block 506. However, if resource 406 fails to successfully load, control passes along line 508 to block 510 which simply displays the default user interface specified by specification 402. Accordingly, if the process of loading modification resource 406 fails, program execution continues to load the default user interface and does not cause an error, nor would the user even be aware of such failure.

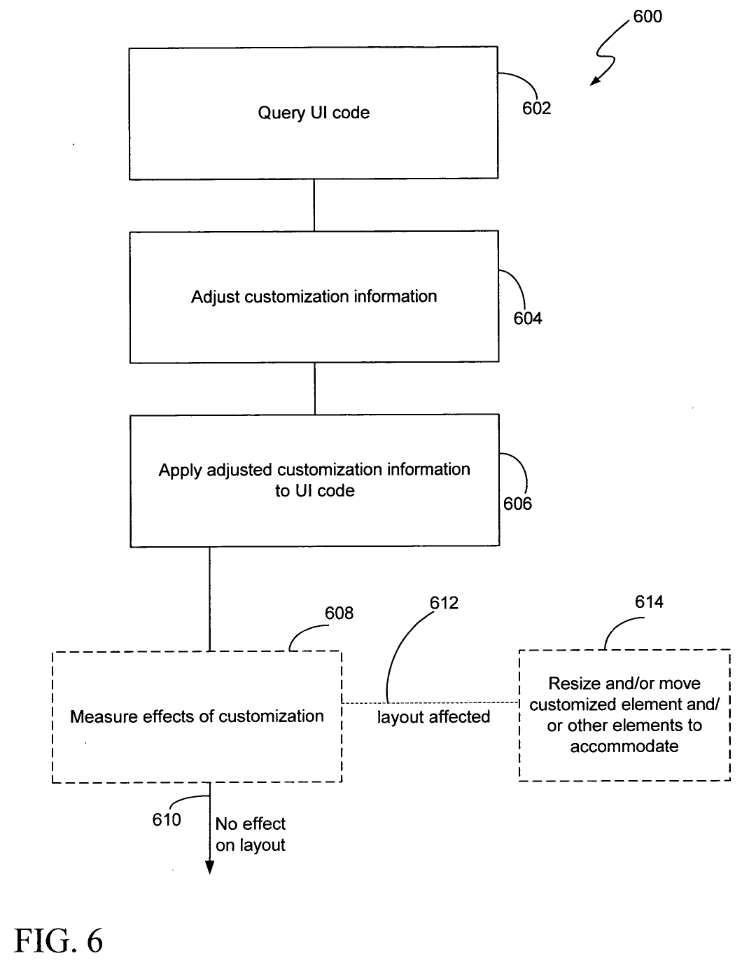

In block 506, the loaded modification resource 406 is parsed to generate a hash table that allows lookup of a user interface element and its associated meta-data. An exemplary element of this hash table is illustrated at block 512 with element 514 having meta-data 516 that includes such things as the name of the user interface element; the property to be customized; the values of those properties; and any nested user interface elements contained within element 514. Once the hash table has been generated at block 506, control passes to block 518 by moving to the first or top element in resource 406. Preferably, resource 406 lists the user interface modifications in a hierarchical manner such that the first element within resource 406 is also the parent of all elements therein. However, this is merely a preference, and many other variations of storage formats within resource 406, and processing regimes can be used. At block 519, the hash table is consulted to lookup any meta-data in the hash table for the element at the top of the chain. Preferably a data structure, such as that illustrated at 514, provides relevant information for that particular user interface element. Once the information has been obtained from the lookup table, control passes to block 520 where the customization is applied to the appropriate user interface element. A more detailed description of the application of a customization is described below with respect to FIG. 6. Once the customization has been applied, control passes to block 522 where it is determined whether the just-customized element contains any nested user interface elements. If so, control returns to block 519 and the process repeats for the nested element. This recursion is preferred for its simplicity. However, if no user interface elements are nested, control passes along line 524 to block 510, which displays the now-customized user interface.

FIG. 6 is a flow diagram of a method 600 for applying a customization to a specific user interface element. Method 600 is preferably executed each time step 520 (illustrated with respect to FIG. 5) is executed. Method 600 begins at block 602 where the user interface code itself within application 400, or specification 402 is actually queried. The ability to query or otherwise determine aspects of programming code is a relatively new, but known concept. Generally speaking, this is accomplished by using one or more meta-data application programming interfaces (APIs) to determine information about the user interface code. For example, within Microsoft's .NET programming framework, this ability is called “reflection.” The ability to query the code provides an important advantage to embodiments of the present invention. Specifically, it allows the application to understand the nature of the user interface code itself. Thus, a developed writing modification information for resource 406 need not specifically know all of the relevant variable declarations and types for the user interface element that the developer is modifying. Instead, at run-time, the program will use the metadata API to query the user interface code to determine, for example, the data type of a user interface element being modified. Then, the associated modification information can be type-cast into the appropriate form to directly modify the user interface element without generating an error. Thus, a user interface modification specification 406 written entirely in textual data can modify any suitable types of user interface elements with the textual data being type-cast, as appropriate, as the user interface element(s) is/are modified. Thus, at block 604, depending on the results of the user interface code query of block 602, the customization information relative to the user interface element is adjusted.

At block 606, the adjusted customization information is applied to the user interface code. In some embodiments, the customization of a user interface element may change the layout or size of that particular user interface element. This layout change may then interfere with one or more other elements in the user interface.

In accordance with embodiments of the present invention, once the adjusted customization information is applied as described with respect to block 606, the effect of the customization is actually measured, or otherwise obtained, as illustrated in optional block 608. For example, if the text of a control is changed from “button” to “customized_button” the actual length of the text will likely require the physical control, such as a button, to become larger as well. The larger button may then not align properly with other controls, or it may even overlap other controls.

If the customized element will not impact user element layout, control passes along line 610 and method 600 ends. However, if the layout will be impacted, control passes along 612 to block 614 where the actual layout of the user interface is adjusted to accommodate the re-sized customized UI element. This accommodation can take the form of simply moving one or more elements that may otherwise interfere with the adjusted UI element. However, adjusting the layout to accommodate the re-sized user interface element can also include adjusting other elements to align them with the re-sized element. For example, if the re-sized button becomes wider than all other buttons, it may be used to generate a button width for all other buttons that are aligned vertically with the re-sized button. Additionally, another aspect of user interface element modification includes the ability to allow resource 406 to specify a completely new location on the user interface for a modified element.

In conclusion, embodiments of the present invention generally allow high quality user interface customization to be done without re-compiling applications. Moreover, if the customization should fail, for one reason or another, applications, in accordance with embodiments of the present invention, simply load a default user interface.

Although the present invention has been described with reference to particular embodiments, workers skilled in the art will recognize that changes may be made in form and detail without departing from the spirit and scope of the invention.

What is claimed is:

1. A system for generating a user interface on a display of a computing device, the system comprising:
an application in the form of instructions readable by the computing device, the application having a default user interface having at least one user interface element;
data indicative of a location of a user interface modification resource;
wherein the user interface modification resource includes modification information relative to the at least one user interface element of the default interface; and
wherein the user interface is generated based on at least one of the default user interface and the user interface modification resource.

2. The system of claim 1, wherein the data is contained within the application.

3. The system of claim 1, wherein the user interface modification resource is in the form of XML.

4. The system of claim 1, wherein the user interface is in the form of a database.

5. The system of claim 1, wherein the application determines if information specified in the user interface modification resource will generate a change in user interface layout, and selectively adjusts at least one other user interface element to accommodate the change.

6. A method of generating a user interface on a display of a computing device, the method comprising:
starting an application on the computing device;
causing the application to attempt to access a user interface modification resource; and
generating a default user interface if the attempt fails.

7. A method of generating a user interface on a display of a computing device, the method comprising:
starting an application having a default user interface on the computing device;
causing the application to attempt to access a user interface modification resource; and
obtaining customization information relative to at least on user interface element from the user interface modification resource; and
generating a user interface on the computing device by applying the customization information to the default user interface.

8. The method of claim 7, and further comprising generating a hash table based on the user interface modification resource.

9. The method of claim 7, wherein layout of the user interface is adjusted based on a size of at least one customized user interface element.

10. The method of claim 9, wherein adjusting the layout includes modifying a layout parameter of at least one other user interface element.

11. The method of claim 10, wherein the layout parameter is position.

12. The method of claim 10, wherein the layout parameter is size.

13. The method of claim 7, wherein generating the user interface includes applying customization information to each user interface element specified in the user interface modification resource.

14. The method of claim 13, wherein the step of applying customization information to each user interface is done recursively.

15. The method of claim 7, wherein the user interface modification resource is in XML.

16. The method of claim 7, wherein the user interface modification resource is a database.

17. The method of claim 7, wherein the user interface modification resource is stored on the computing device.

18. The method of claim 7, wherein the user interface modification resource is stored remote from the computing device, and wherein the application is provided with information indicative of a location of the user interface modification resource.
